(19) United States
(12) Patent Application Publication
(10) Pub. No.: US 2007/0028657 A1
(43) Pub. Date: Feb. 8, 2007

(54) Strengthened lock structure

(75) Inventors: Chao-Ming Huang, Kaohsiung Hsien (TW); Chi-Ming Chen, Kaohsiung Hsien (TW)

Correspondence Address: BACON & THOMAS, PLLC, 625 SLATERS LANE, FOURTH FLOOR, ALEXANDRIA, VA, 22314, US

(73) Assignee: Taiwan Fu Hsing Industrial Co., Ltd., Kaohsiung Hsien (TW)

(21) Appl. No.: 11/197,433

(22) Filed: Aug. 5, 2005

(51) Int. Cl. E05B 13/10

(52) U.S. Cl. 70/224

(57) ABSTRACT

A strengthened lock structure is disclosed. The lock structure has an outdoor handle group, a bolt, and an indoor handle group. Two first legs of the outdoor handle group are inserted to a respective first location hole and a second location hole defined in the bolt, and a bar of the outdoor handle group is inserted to a first hole defined in the bolt. In this way, the two first legs and the bar form a three point engagement between the outdoor handle and the bolt, whereby the engagement strength between the outdoor handle (11) and the bolt is enhanced to prevent forced entry.

### BACKGROUND OF THE INVENTION

1. Field of the Invention

The present invention relates to a strengthened lock structure, and particularly relates to a strengthened lock structure that can firmly secure the lock and effectively prevent forced entry.

2. Description of Related Art

Generally, a lock structure comprises an indoor handle, an outdoor handle, a bolt and certain other parts. The indoor handle normally has a button mounted thereon, and the user can lock the door by pushing the button, thus others can not open the door from the outside. Only those who have the key to the lock can open the door by inserting the key to the keyhole to deactivate the locking status, and then the door is opened by turning the outdoor handle.

The indoor handle has two first fixing shafts inserted to the locating hole defined in the bolt, and the bolt has an opening defined in the center in which a bar of the outdoor handle is inserted. Two second shafts formed on the outdoor handle are inserted through the outdoor blocking plate and indoor blocking plate. Therefore, the outdoor handle has only the bar to engage with the bolt, which is weak compared with the engagement between the indoor handle and the bolt. Burglars etc may destroy the lock by exerting great power on the outdoor handle to separate the outdoor handle and the bolt, so it is necessary to strengthen the engagement between the outdoor handle and the bolt to achieve better prevention of burglary.

Therefore, the invention provides a strengthening device for a lock to mitigate or obviate the aforementioned problems.

### SUMMARY OF THE INVENTION

The main objective of the present invention is to provide a strengthened lock structure that has an outdoor handle group, a bolt and an indoor handle group.

The outdoor handle group includes an outdoor handle, an outdoor plate and an outdoor blocking plate; the indoor handle group includes an indoor handle, an indoor plate and an indoor blocking plate.

Two first legs mounted on the outdoor plate and a bar together form a three point engagement between the outdoor handle and the bolt, whereby the engagement strength between the outdoor handle and the bolt is enhanced to prevent forced entry.

Other objectives, advantages and novel features of the invention will become more apparent from the following detailed description when taken in conjunction with the accompanying drawings.

### BRIEF DESCRIPTION OF THE DRAWINGS

FIG. 1 is an exploded view of the strengthened lock structure in accordance with this invention;

FIG. 2 is a perspective view of the strengthened lock structure in accordance with this invention;

FIG. 3 is a sectional view of the strengthened lock structure in accordance with this invention;

FIG. 4 is a schematic illustration showing two first locating members mounted on the strengthened lock structure;

FIG. 5 is a sectional view showing two first locating members mounted on the outdoor blocking plate of the strengthened lock structure;

FIG. 6 is a schematic illustration showing two second locating members mounted on the outdoor blocking plate of the strengthened lock structure;

FIG. 7 is a part sectional view showing two second locating members respectively received in the two third holes defined in the door;

FIG. 8 is an exploded view showing the rotating major sleeve and the minor sleeve of the outdoor handle plate of the strengthened lock structure; and

FIG. 9 is a perspective view showing the combination of the rotating major sleeve and the minor sleeve of the outdoor handle plate of the strengthened lock structure.

### DETAILED DESCRIPTION OF THE PREFERRED EMBODIMENT

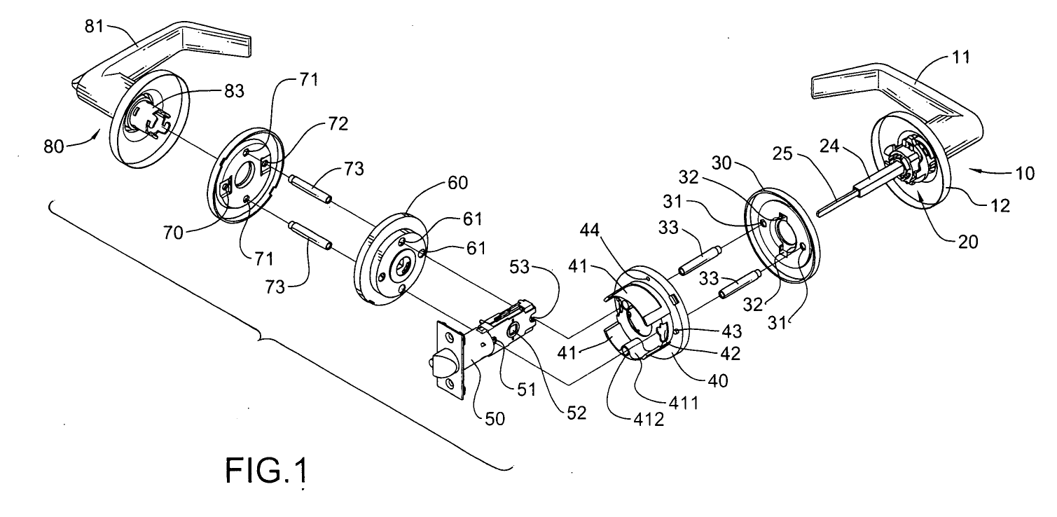

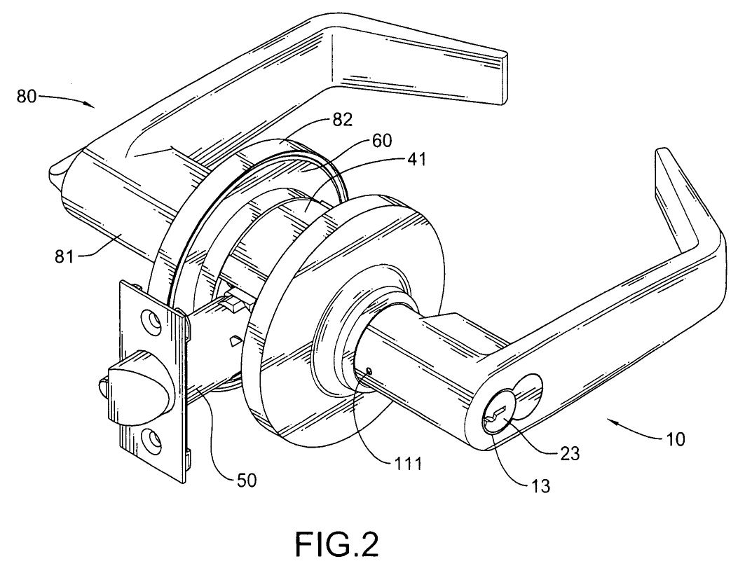

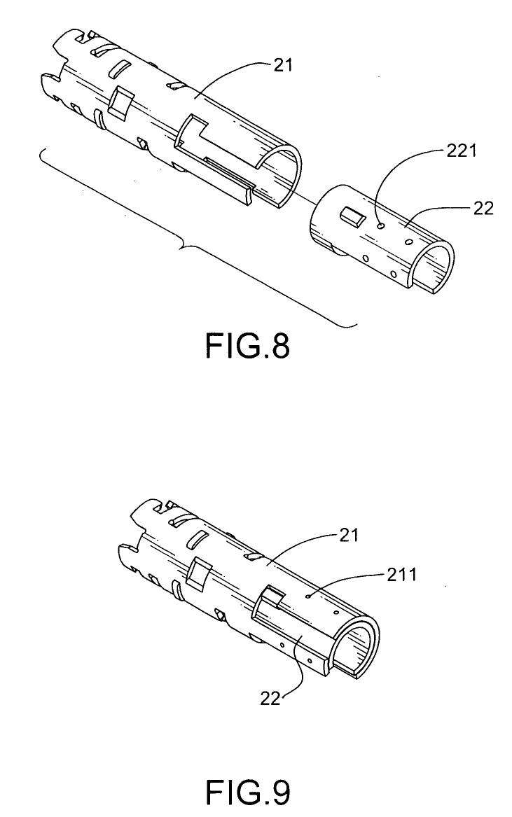

With reference to FIGS. 1-3 and FIG. 8 a strengthened lock structure comprises an indoor handle group (80), an outdoor handle group (10) and a bolt (50). The outdoor handle group (10) includes an outdoor handle (11), an outdoor plate (30) and an outdoor blocking plate (40). The indoor handle group (80) includes an indoor handle (81), an indoor plate (70) and an indoor blocking plate (60).

The outdoor handle (11) has a blocking element (20), which has a first rotating major sleeve (21) with multiple rivet dents (211) formed thereon. The first rotating major sleeve (21) has a polygonal bar (24) mounted therein with a shaft (25) mounted extended out of the bar (24). The bar (24) is inserted through the outdoor plate (30), the outdoor blocking plate (40) and a first passage (52) defined in the bolt (50). A first location hole (51) and a second location hole (53) are defined beside the first passage (52). Two first legs (33) are mounted on the outdoor plate (30) and the two first legs (33) align with the two location holes (51), (53).

The outdoor plate (30) has a first opening defined in the center, two second holes (31) defined in a horizontal line beside the first opening, and two slots (32) defined in a vertical line beside the first opening. A first end of each first leg (33) is inserted to a corresponding one of the second holes (31), and then the first end of each first leg (33) is deformed to prevent its escape from the respective second hole (31).

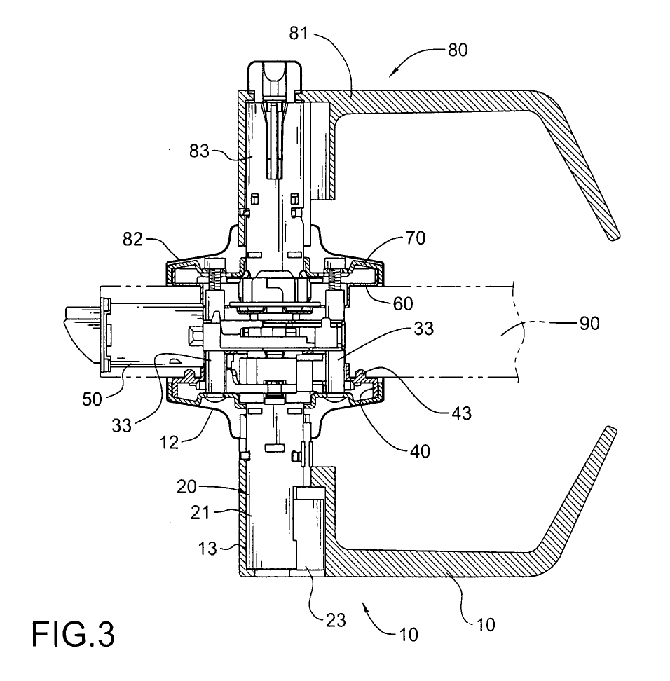

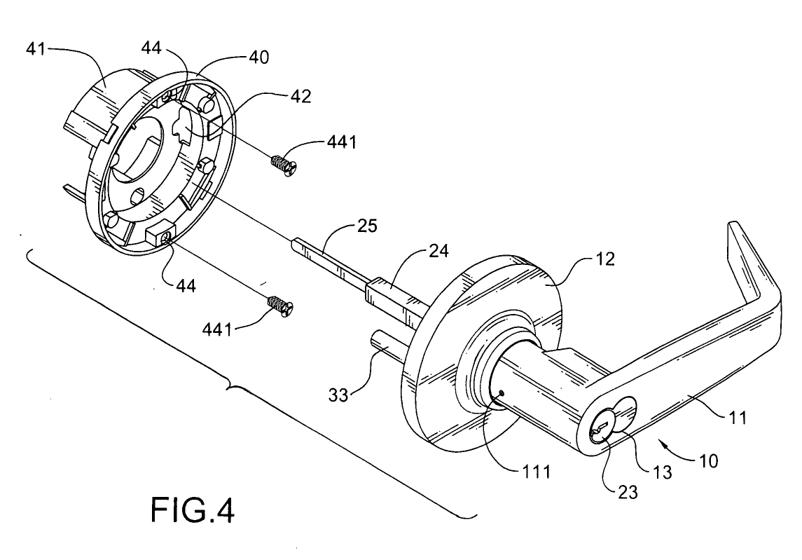

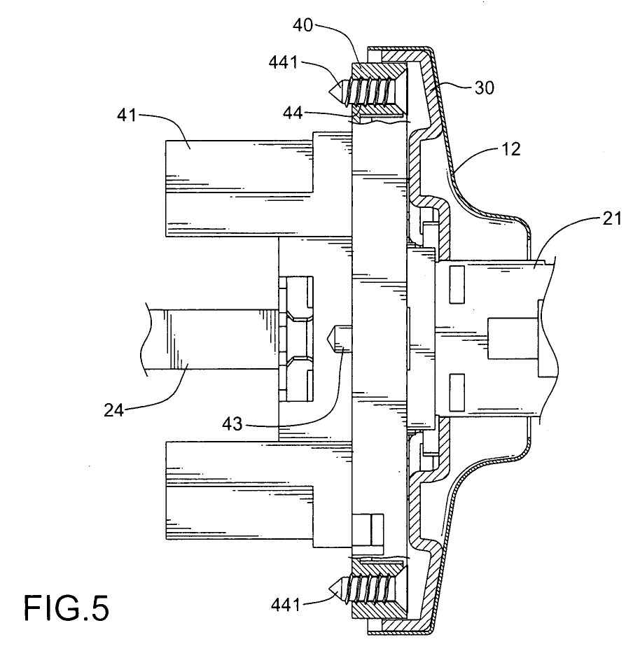

With reference to FIGS. 3-5, the outdoor blocking plate (40) has a second opening defined in the center, and two ear portions (41) formed respectively in upper and lower sides of the outdoor blocking plate (40). Two first side holes (42) are defined in the internal area between the two ear portions (41), and two second side holes (44) are defined respectively in upper and lower sides of the outdoor blocking plate (40). A stub (43) extends from the outdoor blocking plate (40) and is adjacent to the first side hole (42). Two locating members are provided on the outdoor blocking plate (40), and the two locating members can be two self-tapping screws (441), which are inserted by force respectively through the second side holes (44). A protruding length of the self-tapping screws (441) can be adjusted, to be the same as the length of the stub (43). When the lock is mounted on the door (90), the securing strength between the outdoor handle (11) and the door is enhanced by the two self-tapping screws (441) and the stub (43).

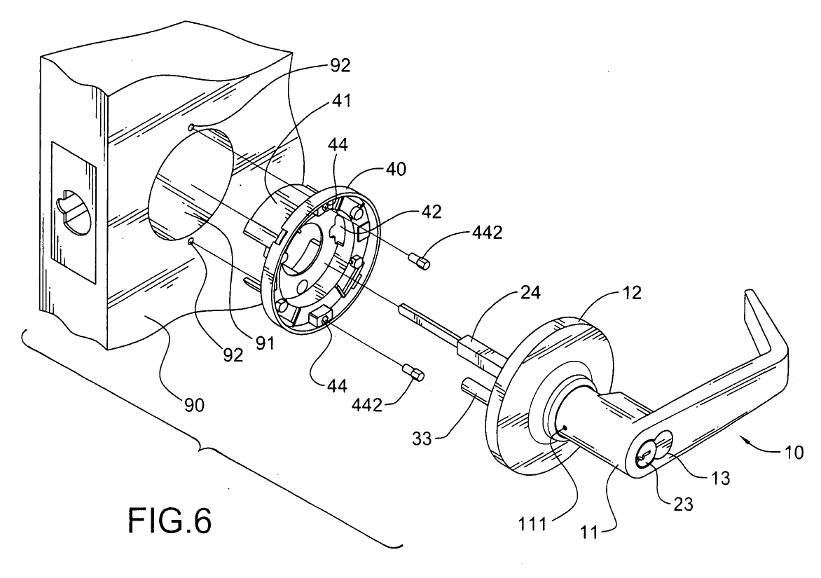

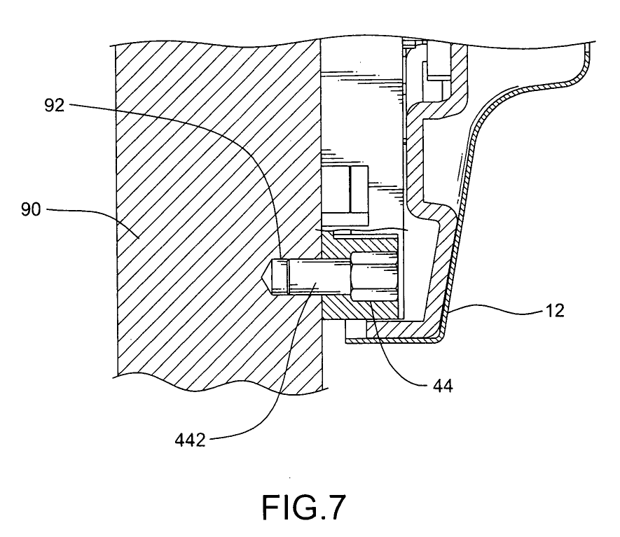

With reference to FIG. 6, the locating member can also be two studs (442), and each stud (442) has a first segment having a round cross section, and a second segment having a polygonal cross section. A polygonal counter sink is defined in each second side hole (44), wherein the second segment of the respective stud (442) is secured in the counter sink of the corresponding second side hole (44). The first segment of each stud (442) is extended out of the corresponding second side hole (44), and the protruding length of each stud (442) can be adjusted to be the same as the corresponding stub (43). In addition, two third holes (92) are defined beside a cavity (91) in the door (90), and the two locating members are respectively received in the two third holes (92), whereby the lock is strongly secured in the door, and will not turn.

However, the locating members are optional depending on the material from which the door is made. For instance, if the door (90) is made of wood, it is better to have two third holes (92) to respectively receive the locating members; but if the door (90) is made of metal such as stainless steel, the locating members are not necessary, and the stub (43) is enough to fix the lock.

With reference to FIGS. 1-3, FIG. 8 and FIG. 9, the outdoor handle (11) has a core hole (13) to secure the blocking element (20) therein. A minor sleeve (22) has multiple apertures (221) corresponding to the multiple rivet dents (211) defined in the first rotating major sleeve (21). When the minor sleeve (22) is received in the first rotating major sleeve (21) and rotates a certain angular degree, each rivet dent (211) is secured in each aperture (221), thus the minor sleeve (22) is fixed in the first rotating major sleeve (21) and keeps an accurate relative position with the first rotating major sleeve (21). In this way, the “8”-shaped core can be mounted in the core hole (13) easily.

The indoor plate (70) has a third opening defined in the center, two opposed fourth holes (72) defined in the horizontal line beside the opening, and two opposed fifth holes (71) respectively defined in the upper and lower sides of the indoor plate (70). The cross section of the fifth hole (71) is polygonal or round. Two second legs (73) each have a first end and a second end, and the first end is inserted into the fifth hole (71), and then the first end of the second leg (73) is deformed to prevent escape from the respective fifth hole (71).

An indoor fixing plate (82) is formed in a root of the indoor handle (81). A second rotating major sleeve (83) with a button is mounted in the indoor handle (81), and the button is used to lock the door from the inside.

The indoor blocking plate (60) has a fourth opening defined therein, and four sixth holes (61) are defined beside the fourth opening, wherein the two sixth holes (61) are in a horizontal line, and the other two sixth holes (61) are defined in a vertical line.

The indoor fixing plate (82), indoor plate (70) and indoor blocking plate (60) are mounted in turn, and the second rotating major sleeve (83) is extended through the third opening, and the two second legs (73) are extended through the sixth hole (61), and the distal end of each second leg (73) is inserted into the corresponding slot (32).

An outdoor securing plate (12) is mounted at the root of the outdoor handle (11). The outdoor securing plate (12), the outdoor plate (30), and the outdoor blocking plate (40) are mounted in turn, then the blocking element (20) is extended in turn through the first opening of the outdoor plate (30) and the second opening of the outdoor blocking plate (40). The two first legs (33) are inserted to the first side hole (42) of the outdoor blocking plate (40) and the first and second location hole (51, 53) of the bolt (50), and then the two sixth holes (61) that are in a horizontal line, and two opposed fourth holes (72) in the indoor plate (70). A threaded hole is defined in each first leg (33), and two screws are respectively inserted to the threaded holes of the first legs (33) to secure the relative elements. The bar (24) of the blocking element (20) is inserted to the first passage (52) of the bolt (50). In this way, the two first legs (33) and the bar (24) form three point engagements between the outdoor handle (11) and the bolt (50), whereby the engagement strength between the outdoor handle (11) and the bolt (50) is enhanced to prevent forced entry. In addition, the ear portions (41) of the outdoor blocking plate (40) each have a thick member (411) having a seventh hole (412) which receives the corresponding second leg (73), whereby the engagement of the indoor handle (81) and the outdoor handle (11) is enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A strengthened lock structure comprising:
an indoor handle group (80), a bolt (50) and an outdoor handle group (10), wherein the outdoor handle group (10) comprises an outdoor handle (11), an outdoor plate (30) and an outdoor blocking plate (40), and a blocking element (20) is mounted in the outdoor handle (11), the blocking element (20) has a first rotating major sleeve (21), a bar (24) received in the major sleeve (21) with a shaft (25) extended from the bar (24) and the bar (24) is inserted through the outdoor plate (30), the blocking plate (40) and a first passage (52) defined in the bolt (50);
a first location hole (51) and a second location hole (53) defined beside the first passage (52); and
two first legs (33) mounted on the outdoor plate (30) and the first legs respectively aligning with the two location holes (51,53).

2. The strengthened lock structure as referred in claim 1, wherein the outdoor plate (30) has a first opening, two second holes (31) defined in a horizontal line beside the first opening, and two slots (32) defined in a vertical line beside the opening, the two first legs (33) are mounted on the outdoor plate (30), and the first legs (33) are inserted in a corresponding one of the second holes (31).

3. The strengthened lock structure as referred in claim 1, wherein the outdoor blocking plate (40) has a second opening defined in a center of the outdoor blocking plate (40), and two ear portions (41) are respectively formed in upper and lower sides of the outdoor blocking plate (40); two first side holes (42) are defined in an internal area between the two ear portions (41), and two second side holes (44) are respectively defined in upper and lower sides of the outdoor blocking plate (40); a stub (43) extends from the outdoor blocking plate and is adjacent to the first side hole (42), and two locating members are provided on the outdoor blocking plate (40).

4. The strengthened lock structure as referred in claim 2, wherein the outdoor blocking plate (40) has a second opening defined in a center of the outdoor blocking plate, and two ear portions (41) are respectively formed in upper and lower sides of the outdoor blocking plate (40), and two first side holes (42) are respectively defined in an internal area between the two ear portions (41), and two second side holes (44) are respectively defined in upper and lower sides of the outdoor blocking plate (40), a stub (43) extends from the outdoor blocking plate and is adjacent to the first side hole (42), and two locating members are provided on the outdoor blocking plate (40).

5. The strengthened lock structure as referred in claim 3, wherein the two locating members are self-tapping screws.

6. The strengthened lock structure as referred in claim 4, wherein the two locating members are self-tapping screws.

7. The strengthened lock structure as referred in claim 3, wherein the locating member is studs (442) and each stud (442) has a first segment having a round cross section, and a second segment having a polygonal cross section, and a polygonal counter sink is defined in each second side hole.

8. The strengthened lock structure as referred in claim 4, wherein the locating member is two studs (442) and each stud (442) has a first segment having a round cross section, and a second segment having a polygonal cross section, and a polygonal counter sink is defined in each second side hole.

9. The strengthened lock structure as referred in claim 3, wherein the ear portions (41) of the outdoor blocking plate (40) each have a thick member (411) having a seventh hole (412).

10. The strengthened lock structure as referred in claim 4, wherein the ear portions (41) of the outdoor blocking plate (40) each have a thick member (411) having a seventh hole (412).
